(19) United States
(12) Patent Application Publication
(10) Pub. No.: US 2006/0245652 A1
(43) Pub. Date: Nov. 2, 2006

(54) Method for recognizing objects in an image without recording the image in its entirety

(75) Inventor: Mei-Ju Chen, Hsinchu Hsien (TW)

Correspondence Address: HARNESS, DICKEY, & PIERCE, P.L.C, 7700 BONHOMME, STE 400, ST. LOUIS, MO, 63105, US

(73) Assignee: Pixart Imaging Inc.

(21) Appl. No.: 11/409,584

(22) Filed: Apr. 24, 2006

(30) Foreign Application Priority Data
May 2, 2005 (TW) 094114113

(51) Int. Cl. G06K 9/00

(52) U.S. Cl. 382/181; 382/195

(57) ABSTRACT

An image recognition method is used to recognize objects in an image in real-time and without requiring storage of the image in an image buffer. Each object is formed from image segments. The method includes: setting a grayscale threshold value of the image; acquiring pixel values of each row sequentially in the image; determining a start point of a newly detected image segment located in a currently inspected row of the image; collecting information of the newly detected image segment point-by-point starting from the start point; determining an end point of the newly detected image segment; identifying the object to which the newly detected image segment belongs according to a spatial correlation between the newly detected image segment and a previously detected image segment in an adjacent previously inspected row of the image; and associating the collected information of the newly detected image segment with the identified object to which the newly detected image segment belongs.

### CROSS-REFERENCE TO RELATED APPLICATION

This application claims priority of Taiwanese Application No. 094114113, filed on May 2, 2005.

### BACKGROUND OF THE INVENTION

1. Field of the Invention

The invention relates to an image recognition method, more particularly to a method for recognizing objects in an image in real-time without recording the image in its entirety.

2. Description of the Related Art

For current image processing techniques, recognition of an arbitrary number of objects in an image oftentimes requires use of different image recognition algorithms. However, calculations in such conventional algorithms grow in complexity with an increase in the number of the objects to be recognized in an image. For instance, complicated region growing computational rules have to be used such that the entire image (full image) has to be stored in an image buffer of an image processing system in advance, and complicated identification procedures are needed to be performed to recognize each object in the full image after all the image information has been collected. Hence, the traditional recognition process not only utilizes a large amount of memory resources of the image buffer, but also consumes much time.

### SUMMARY OF THE INVENTION

Therefore, an object of the present invention is to provide a method for recognizing objects in an image which does not require the use of an image buffer so as to achieve savings in memory resources.

Another object of the present invention is to provide a method for recognizing objects in an image, which has expandability and which can recognize each object in the image in real-time without being limited by the number of objects in the image.

Accordingly, the method for recognizing objects in an image of the present invention is implemented using an image sensor and a register. The image sensor includes a plurality of pixel sensing elements arranged in rows and capable of sensing the image in a row-by-row manner such that linear image segments of the objects in the image captured by the image sensor are sensed by corresponding rows of the pixel sensing elements. The method includes the following steps: (A) setting a grayscale threshold value of the image; (B) acquiring pixel values of each row sequentially in the image; (C) determining according to the grayscale threshold value and storing in the register a start point of a newly detected linear image segment located in a currently inspected row of the image; (D) collecting information of the newly detected linear image segment point-by-point starting from the start point, and storing the information in the register; (E) determining according to the grayscale threshold value and storing in the register an end point of the newly detected linear image segment; (F) identifying the object to which the newly detected linear image segment belongs according to a spatial correlation between the newly detected linear image segment and a previously detected linear image segment in an adjacent previously inspected row of the image; and (G) associating the collected information of the newly detected linear image segment with the identified object to which the newly detected linear image segment belongs.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit block diagram showing an image processing system for implementing the preferred embodiment of a method for recognizing objects in an image according to the present invention;

FIG. 2 is a schematic diagram illustrating how the preferred embodiment can be used to recognize an arbitrary number of objects in an image; and

FIG. 3 is a flowchart illustrating consecutive steps of the preferred embodiment.

### DETAILED DESCRIPTION OF THE PREFERRED EMBODIMENT

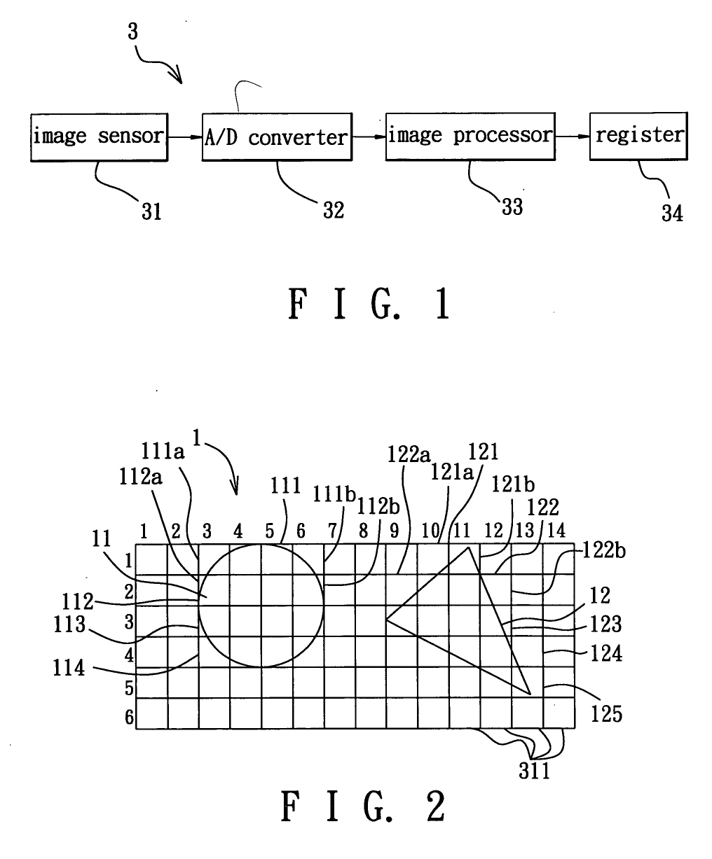

Referring to FIG. 1, the preferred embodiment of a method for recognizing objects in an image according to the present invention is implemented using an image processing system 3. The image processing system 3 includes an image sensor 31, an analog-to-digital converter (A/D converter) 32, an image processor 33, and a register 34. The image sensor 31 may be a CCD or CMOS sensor, and is used to generate an analog output corresponding to light rays from a captured object (not shown). The analog output is provided to the A/D converter 32 for conversion to a digital signal. The image processor 33 is responsible for signal processing and computations.

It is noted that the image processing system 3 in this embodiment can be used in an image capturing device, such as a video camera, to provide the same with an image recognition function. In other embodiments, the image processing system 3 may be implemented as recognition software installed in a computer. In addition, since the structures of the image sensor 31, the A/D converter 32 and the image processor 33 are well known in the art, and since the feature of the present invention resides in the use of the image processor 33 in combination with the register 34 to perform the image recognition function, only those components which are pertinent to the feature of the present invention will be discussed in the succeeding paragraphs.

Referring to FIGS. 1 and 2, the method of the present invention can be used to recognize an arbitrary number of objects in an image 1 sensed by the image sensor 31 without requiring the image 1 to be recorded in its entirety in an image buffer. In this embodiment, the image 1 has objects to be recognized, which are exemplified using a circular object 11 and a triangular object 12 in the following description of the steps of the method according to this invention.

It is noted that the image sensor 31 includes a plurality of pixel sensing elements 311 arranged in rows and capable of sensing the image 1 in a row-by-row manner such that linear image segments of the objects 11, 12 in the image 1 captured by the image sensor 31 are sensed by corresponding rows of the pixel sensing elements 311. For example, the circular object 11 shown in FIG. 2 has four linear image segments 111-114, while the triangular object 12 has five linear image segments 121-125.

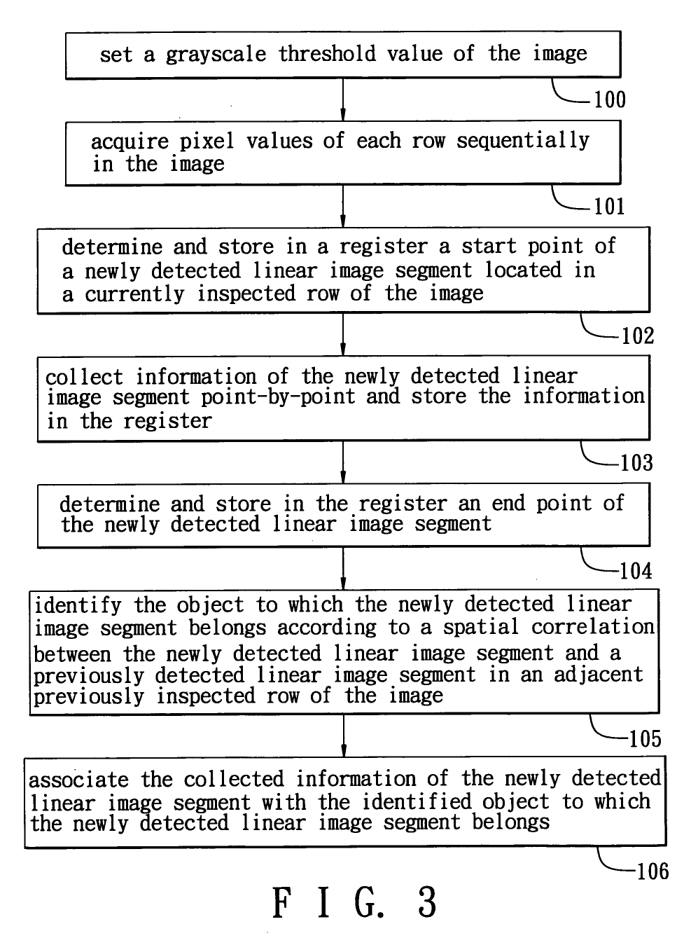

With reference to FIGS. 1 to 3, the steps of, as well as the principles behind, the method for recognizing objects in an image according to the present invention will now be described in detail as follows.

Initially, in step 100, a grayscale threshold value of the image 1 is set. In step 101, pixel values of each row in the image 1 are acquired sequentially from the image sensor 31. That is, starting from the first row, the pixel values of the image 1 are inspected row-by-row and from left to right. During the inspection process, a start point of a newly detected linear image segment of an object in the image 1, the newly detected linear image segment being located in a currently inspected row of the image 1, is determined and stored in the register 34, as in step 102. In step 103, information of the newly detected linear image segment is collected point-by-point starting from the start point and is stored in the register 34. Then, in step 104, an end point of the newly detected linear image segment is determined and stored in the register 34. The determination of presence of the newly detected linear image segment in the aforesaid steps 102 to 104 is made by comparing the pixel values with a system predetermined threshold value. In step 105, the object to which the newly detected linear image segment belongs is identified according to a spatial correlation between the newly detected linear image segment and a previously detected linear image segment in an adjacent previously inspected row of the image 1.

In this embodiment, the newly detected linear image segment is determined to belong to an object i if the following equations are satisfied:
Seg-L≦Preline-Objᵢ-R;
and
Seg-R≧Preline-Objᵢ-L

where, assuming that the y^{th} row of the image 1 is currently being inspected, Seg-L represents the X-axis coordinate of a left start point of the newly detected linear image segment found in the y^{th} row; Preline-Objᵢ-R represents the X-axis coordinate of a right end point of a previously detected linear image segment of the object i that was found in the (y−1)^{th} row of the image 1; Seg-R represents the X-axis coordinate of a right end point of the newly detected linear image segment found in the y^{th} row; and Preline-Objᵢ-L represents the X-axis coordinate of a left start point of the previously detected linear image segment of the object i that was found in the (y−1)^{th} row.

In step 106, the collected information of the newly detected linear image segment is associated with the object to which it belongs. Determination of presence of another newly detected linear image segment is made in the same manner as described above. When all the pixel values of the image 1 have been inspected, recognition of the objects 11, 12 at different positions of the image 1 is accomplished.

Referring to FIGS. 1 and 2, assuming the pixels values of the image 1 are read row by row starting from the first row, since a pixel value greater than the system predetermined threshold value appears at coordinates (3,1), the coordinates of a left start point 111a of a newly detected linear image segment 111 of the object 11 are stored in the register 34. Then, information of the newly detected linear image segment 111 is collected point-by-point and stored in the register 34 until a right end point 111b of the newly detected linear image segment 111 is determined. Subsequently, coordinates of the right end point 111b are stored in the register 34. However, since there is another newly detected linear image segment 121 in the first row of the image 1, coordinates of a left start point 121a and a right end point 121b of the newly detected linear image segment 121, as well as point-by-point information of the newly detected linear image segment 121 are also stored in the register 34.

Subsequently, coordinates of left start points 112a, 122a, as well as coordinates of right end points 112b, 122b, of newly detected linear image segments 112, 122 in the following row (i.e., the second row) are determined and stored. Upon determining the right end point 112b, 122b of one of the newly detected linear image segments 112, 122, a determination is made based on the aforesaid equations as to whether the newly detected linear image segment 112, 122 belongs to one of the objects 11, 12. The coordinates of start and end points of linear image segments of the objects 11, 12 in the image 1 are thus determined and stored row-by-row in the above-described manner and in a pattern going from left to right and from top to bottom. After all the pixel values of the image 1 have been inspected, real-time recognition of the objects 11, 12 in the image 1 is completed.

In sum, the method for recognizing objects in an image according to the present invention has the following advantages:

1. The image recognition method of this invention can be employed to perform real-time image recognition using a register without requiring storage of an entire image in an image buffer, thereby saving memory resources.

2. The algorithm adopted in the image recognition method of this invention is simple and is not constrained by the number of objects in an image. Therefore, the present invention can be used to recognize any number of objects in an image. The present invention has good expandability, and is capable of real-time recognition of objects in an image.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for recognizing objects in an image, said method being implemented using an image sensor and a register, the image sensor including a plurality of pixel sensing elements arranged in rows and capable of sensing the image in a row-by-row manner such that linear image segments of the objects in the image captured by the image sensor are sensed by corresponding rows of the pixel sensing elements, said method comprising the following steps:
(A) setting a grayscale threshold value of the image;
(B) acquiring pixel values of each row sequentially in the image;
(C) determining according to the grayscale threshold value and storing in the register a start point of a newly detected linear image segment located in a currently inspected row of the image;
(D) collecting information of the newly detected linear image segment point-by-point starting from the start point, and storing the information in the register;
(E) determining according to the grayscale threshold value and storing in the register an end point of the newly detected linear image segment;
(F) identifying the object to which the newly detected linear image segment belongs according to a spatial correlation between the newly detected linear image segment and a previously detected linear image segment in an adjacent previously inspected row of the image; and
(G) associating the collected information of the newly detected linear image segment with the identified object to which the newly detected linear image segment belongs.

2. The method as claimed in claim 1, wherein, in step (F), the object to which the newly detected linear image segment belongs is identified based on the following equations such that the newly detected linear image segment is determined to belong to the object i when the following equations are satisfied:
Seg-L-<Preline-Objᵢ-R;
and
Seg-R≧Preline-Objᵢ-L
where, when the y^{th} row of the image is currently being inspected, Seg-L represents the X-axis coordinate of a left start point of the newly detected linear image segment found in the y^{th} row; Preline-Objᵢ-R represents the X-axis coordinate of a right end point of a previously detected linear image segment of the object i that was found in the (y−1)^{th} row of the image; Seg-R represents the X-axis coordinate of a right end point of the newly detected linear image segment found in the y^{th} row; and Preline-Objᵢ-L represents the X-axis coordinate of a left start point of the previously detected linear image segment of the object i that was found in the (y−1)^{th} row.
